(19) United States
(12) Patent Application Publication
(10) Pub. No.: US 2023/0219331 A1
(43) Pub. Date: Jul. 13, 2023

(54) MULTILAYER STRUCTURES, LAMINATES, AND RELATED ARTICLES

(71) Applicant: Dow Global Technologies LLC, Midland, MI (US)

(72) Inventors: Bo Lv, Zhejiang (CN); Xiaobing Yun, Shanghai (CN); Jianping Pan, Shanghai (CN); Jingyi Xu, Shanghai (CN); Jichang Feng, Shanghai (CN)

(21) Appl. No.: 17/998,950

(22) PCT Filed: Jul. 30, 2020
(86) PCT No.: PCT/CN2020/105716

§ 371 Date: Nov. 16, 2022

(51) Int. Cl. B32B 27/32; B32B 27/08; B32B 27/30; B32B 7/12

(52) U.S. Cl. CPC B32B 27/32; B32B 27/08; B32B 27/308; B32B 7/12; B32B 2255/205; B32B 2255/10; B32B 2250/24; B32B 2250/03; B32B 2307/72

(57) ABSTRACT

Provided are multilayer structures, laminates and articles formed from such structures. In one aspect, a multilayer structure comprises (a) a multilayer polyethylene film, wherein an outer layer of the film comprises a polymer blend of at least one ethylene-based polymer and at least one ethylene acid copolymer, wherein the difference between the melt index (I2) of the ethylene acid copolymer and the ethylene-based polymer is less than 18, and wherein the acid content of the polymer blend is greater than 0.2%; and (b) a metal layer comprising a metal deposited on the outer layer of the polyethylene film.

### FIELD

The present invention relates to multilayer structures, to laminates comprising such multilayer structures, and to articles comprising such multilayer structures or laminates.

### FIELD

Some packages such as food packages are designed to protect the contents from the external environment and to facilitate a longer shelf. Such packages are often constructed using barrier films with low oxygen transmission rates (OTR) and water vapor transmission rates (WVTR). However, in balancing the barrier properties, consideration is also given to package integrity to, for example, avoid leakage.

To make barrier films, a typical approach is to place a metal layer on polymeric substrate films through vacuum metallization process. A thin coating of metal, often aluminum, can be used to provide barrier properties to polymeric films which may on their own lack resistance to the permeation of vapors and/or gases. In order to make such substrate film and gain a high quality metallized product, the substrate should generally have high stiffness, dimensional stability under tension, and a smooth surface for stable production and a glossy appearance. Typical metalized substrates include polypropylene (PP), biaxially oriented polypropylene (BOPP), and polyethylene terephthalate (PET).

Vacuum metallized BOPP structures and vacuum metallized PET structures have been widely used in food packaging. A conventional multilayer structure utilizes three films: a printed PET outer layer (e.g., with product information, branding, decor, etc.), a middle layer that is a metallized BOPP or metallized PET structure, and a polyethylene inner layer for sealing (e.g., a sealant film).

Polyethylene films are not widely used as substrates for metallization due to their inferior dimensional stability under tension especially in high-speed vacuum metallization processes and also due to a need for excellent adhesion between the metal layer and the polyethylene film. For example, it is hypothesized that weak adhesion between a vacuum metallized aluminum layer and a polyethylene film surface could cause defects in the aluminum layer, which could then provide pathways for oxygen/water vapor to pass through the film and lead to a lack of good barrier properties.

There remains a need for new approaches to multilayer structures that provide good barrier properties, good adhesion between a metal layer and a film layer, desirable package integrity, favorable sealing conditions, and other properties.

### SUMMARY

The present invention provides multilayer structures that are metallized polyethylene films having good adhesion between the metal layer and an outer layer of the polyethylene film. Such multilayer structures can provide a good synergy of a barrier properties and sealing properties in a single metallized film. For example, the multilayer structures of the present invention, in some embodiments, can be used instead of previous structures that included a metallized BOPP film (or a metallized BOPET film) laminated to a polyethylene sealant film. This results in a simpler structure for use laminates or articles (a single metallized films instead of a metallized film and a sealant film). Multilayer structures of the present invention, in some embodiments, can be laminated to a second film that comprises polyamide, polyethylene terephthalate, polypropylene, or polyethylene, which results in a laminate that can be used in articles. Such laminates, according to some embodiments of the present invention, include only two films instead of three films due to the advantages provided by the inventive multilayer structures.

In one aspect, the present invention provides a multilayer structure that comprises a (a) a multilayer polyethylene film, wherein an outer layer of the film comprises a polymer blend of at least one ethylene-based polymer and at least one ethylene acid copolymer, wherein:
(1) the ethylene-based polymer comprises ethylene α-olefin copolymer, ethylene homopolymer, or combinations thereof, wherein the ethylene-based polymer has a density of from 0.900 to 0.970 g/cm³ and a melt index (I₂) of 0.1 to 20 g/10 minutes; and
(2) the ethylene acid copolymer is the polymerized reaction product of at least 50 wt. % ethylene monomer, based on the total weight of the monomers present in the ethylene acid copolymer and from 1 to 30 wt. % of monomer selected from the group consisting of monocarboxylic acids and dicarboxylic acids, based on the total weight of the monomers present in the ethylene acid copolymer, wherein the ethylene acid copolymer has a melt index (I₂) or 0.7 to 35 g/10 minutes, wherein the difference between the melt index (I₂) of the ethylene acid copolymer and the ethylene-based polymer is less than 18, and wherein the acid content of the polymer blend is greater than 0.2%; and (b) a metal layer comprising a metal deposited on the outer layer of the polyethylene film.

In another aspect, the present invention relates to a laminate comprising any of the inventive multilayer structures disclosed herein and a second film. The second film comprises, in some embodiments, polyamide, polyethylene terephthalate, polypropylene, or polyethylene. In another aspect, the present invention relates to an article, such as a food package, comprising any of the inventive laminates disclosed herein.

In another aspect, the present invention relates to an article, such as a food package, comprising any of the inventive multilayer structures disclosed herein.

These and other embodiments are described in more detail in the Detailed Description.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

“Polypropylene” or “propylene-based polymer” means a polymer having greater than 50 wt % units derived from propylene monomer. The term “polypropylene” includes homopolymers of propylene such as isotactic polypropylene, random copolymers of propylene and one or more C_{2, 4-8} α-olefins in which propylene comprises at least 50 mole percent, and impact copolymers of polypropylene.

The term, “ethylene/α-olefin interpolymer,” as used herein, refers to an interpolymer that comprises, in polymerized form, a majority amount of ethylene monomer (based on the weight of the interpolymer), and an α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and include the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

In one aspect, the present invention provides a multilayer structure that comprises a (a) a multilayer polyethylene film, wherein an outer layer of the film comprises a polymer blend of at least one ethylene-based polymer and at least one ethylene acid copolymer, wherein:
(1) the ethylene-based polymer comprises ethylene α-olefin copolymer, ethylene homopolymer, or combinations thereof, wherein the ethylene-based polymer has a density of from 0.900 to 0.970 g/cm³ and a melt index (I₂) of 0.1 to 20 g/10 minutes; and
(2) the ethylene acid copolymer is the polymerized reaction product of at least 50 wt. % ethylene monomer, based on the total weight of the monomers present in the ethylene acid copolymer and from 1 to 30 wt. % of monomer selected from the group consisting of monocarboxylic acids and dicarboxylic acids, based on the total weight of the monomers present in the ethylene acid copolymer, wherein the ethylene acid copolymer has a melt index (I₂) or 0.7 to 35 g/10 minutes,
   wherein the difference between the melt index (I₂) of the ethylene acid copolymer and the ethylene-based polymer is less than 18, and wherein the acid content of the polymer blend is greater than 0.2%; and (b) a metal layer comprising a metal deposited on the outer layer of the polyethylene film.

Without wishing to be bound by any particular theory, it is believed that the difference between the melt indexes (I₂) of the ethylene acid copolymer and the ethylene-based polymer and the acid content of the polymer blend facilitates adhesion between the metal and the outer layer of the polyethylene film. In some embodiments, the ethylene-based polymer is low density polyethylene or linear low density polyethylene. In some embodiments, the acid monomer comprises acrylic acid, methacrylic acid, or combinations thereof.

The metal layer, in some embodiments, has a thickness of 20 to 60 nanometers. In some embodiments, the metal comprises Al, Si, Zn, Au, Ag, Cu, Ni, Cr, Ge, Se, Ti, Sn, oxides thereof, and combinations thereof. In some embodiments, the metal comprises Al metal, oxides of Al, or both. The metal, in some embodiments, is deposited on the polyethylene film by vacuum metallization.

In some embodiments, the outer layer further comprises 200 to 4000 ppm fluoroelastomer processing aid based on the weight of the outer layer of the polyethylene film. The fluoroelastomer processing aid, in some embodiments, can be a copolymer of vinylidene fluoride and a comonomer selected from hexafluoropropylene, chlorotrifluoroethylene, 1-hydropentafluoropropylene, and 2-hydropentafluoropropylene; a copolymer of vinylidene fluoride, tetrafluoroethylene, and hexafluoropropylene or 1- or 2-hydropentafluoropropylene; or a copolymer of tetrafluoroethylene, propylene and, optionally, vinylidene fluoride. In some embodiments, the fluoropolymer processing aid comprises copolymerized units of i) vinylidene fluoride/hexafluoropropylene; ii) vinylidene fluoride/hexafluoropropylene/tetrafluoroethylene; iii) tetrafluoroethylene/propylene; or iv) tetrafluoroethylene/propylene/vinylidene fluoride.

A multilayer structure of the present invention can comprise a combination of two or more embodiments as described herein.

In other aspects, the present invention relates to laminates comprising any of the inventive multilayer structures disclosed herein and a second film. Such laminates comprise any of the inventive multilayer structures disclosed herein adhesively contacted with a second film. The second film comprises, in some embodiments, polyamide, polyethylene terephthalate, polypropylene, or polyethylene.

In other aspects, the present invention relates to an article, such as a food package. In some embodiments, an article comprises any of the inventive multilayer structures disclosed herein. In some embodiments, an article comprises any of the inventive laminates disclosed herein. An article of the present invention can comprise a combination of two or more embodiments as described herein.

### Multilayer Polyethylene Film

Multilayer structures of the present invention comprise a multilayer polyethylene film. The multilayer polyethylene film includes an outer layer that facilitates adhesion of the metal layer (discussed below), in some embodiments, and that advantageously provides a synergistic combination of good barrier properties and sealing properties in a single metallized film.

The polyethylene film is a multilayer film. In some embodiments, the metallized film may serve as a sealant film as part of a laminate comprising at least one other film (e.g., a polyamide film, a polyethylene terephthalate film, a polypropylene film, or a second polyethylene film). In such embodiments, the polyethylene film may comprise a sealant layer which is a second outer layer opposite the outer layer that is metallized.

The outer layer of the multilayer polyethylene film to be metallized comprises a polymer blend of at least one ethylene-based polymer and at least one ethylene acid copolymer. The ethylene-based polymer includes ethylene α-olefin copolymer, ethylene homopolymer, or combinations thereof. The ethylene-based polymer has a density of from 0.900 to 0.970 g/cm³ and a melt index (I2) of from 0.1 to 20 g/10 mins. In some embodiments, the ethylene-based polymer is a low density polyethylene, a linear low density polyethylene (LLDPE), or a combination thereof.

The ethylene-based polymer can include Ziegler-Natta catalyzed linear low density polyethylene, single site catalyzed (including metallocene) linear low density polyethylene, low density polyethylene (LDPE), and high density polyethylene (HDPE) so long as the HDPE has a density no greater than 0.970 g/cm³, as well as combinations of two or more of the foregoing. All individual values and subranges greater than or equal to 0.970 g/cm³ are included herein and disclosed herein; for example, the density of the ethylene-based polymer can be from a lower limit of 0.910, 0.915, 0.920, 0.925, 0.928, 0.931 or 0.934 g/cm³. In some aspects, the ethylene-based polymer has a density less than or equal to 0.970 g/cm³. All individual values and subranges of less than 0.970 g/cm³ are included herein and disclosed herein; for example, the ethylene-based polymer can have a density from an upper limit of 0.965, 0.960, 0.955, 0.950, 0.940, or 0.930 g/cm³. In some embodiments, the ethylene-based polymer has a density from 0.910 to 0.960 g/cm³.

The ethylene-based polymer has a melt index (I₂) less than or equal to 20 g/10 minutes. All individual values and subranges from 20 g/10 minutes are included herein and disclosed herein. For example, the ethylene-based polymer can have an 12 from an upper limit of 20, 18, 15, 14, 13, 12, 11, 10, 9, 8, 7, 6, 5, 4, 3.5, 3, 2.5, 2, 1.9, 1.8, 1.7, 1.6, 1.5, 1.4, 1.3, 1.2, or 1.1 g/10 minutes. In a particular aspect, the ethylene-based polymer has an I₂ with a lower limit of 0.1 g/10 minutes. All individual values and subranges from 0.1 g/10 minutes are included herein and disclosed herein. For example, the ethylene-based polymer can have an I₂ greater than or equal to 0.1, 0.2, 0.3, 0.4, 0.45, or 0.5 g/10 minutes. The ethylene-based polymer used in the at least one layer can be characterized as having a melt index (I₂) of from 0.3 to 20 g/10 mins, from 0.3 to 10 g/10 minutes, from 0.5 to 4 g/10 mins, or even from 0.3 to 1.1 g/10 mins.

In some embodiments, the ethylene-based polymer used in the outer layer upon which the metal will be deposited is a linear low density polyethylene. In some embodiment, the outer layer includes one or more linear low density polyethylenes. The LLDPEs that can be used in the outer layer can include Ziegler-Natta catalyzed linear low density polyethylene, and single site catalyzed (including metallocene) linear low density polyethylene, as well as combinations of two or more of the foregoing.

In some embodiments, the outer layer includes a linear low density polyethylene having a density of 0.900 to 0.940 g/cm³. All individual values and subranges of 0.900 to 0.940 g/cm³ are included herein and disclosed herein; for example, the density of the linear low density polyethylene can be from a lower limit of 0.900, 0.902, 0.904, 0.906, 0.908, 0.910, 0.915, 0.918 or 0.920 g/ cm³ to an upper limit of 0.920, 0.925, 0.930, 0.935, or 0.940 g/cm³. In some embodiments, the linear low density polyethylene has a density from 0.908 to 0.940 g/cm³.

In some embodiments, the linear low density polyethylene has a melt index (I₂) less than or equal to 20 g/10 minutes. All individual values and subranges from 20 g/10 minutes are included herein and disclosed herein. For example, the linear low density polyethylene can have an I₂ upper limit of 20, 18, 15, 14, 13, 12, 11, 10, 9, 8, 7, 6, 5, 4, 3.5, 3, 2.5, 2, 1.9, 1.8, 1.7, 1.6, 1.5, 1.4, 1.3, 1.2, or 1.1 g/10 minutes. In a particular aspect, the linear low density polyethylene has an I₂ with a lower limit of 0.1 g/10 minutes. All individual values and subranges from 0.1 g/10 minutes are included herein and disclosed herein. For example, the linear low density polyethylene can have an I₂ greater than or equal to 0.1, 0.2, 0.3, 0.4, 0.45, or 0.5.

Examples of linear low density polyethylenes that can be used in the outer layer in some embodiments include DOWLEX™ linear low density polyethylenes commercially available from The Dow Chemical Company, such as DOWLEX™ 2045G, DOWLEX™ NG 2038G, and DOWLEX™ 2045.11G, as well as other polyethylenes commercially available from The Dow Chemical Company under the names DOWLEX™ NG, ELITE™, ELITE™ AT, and INNATE™.

In some embodiments, the ethylene-based polymer used in the outer layer upon which the metal will be deposited is a low density polyethylene. In some embodiments, the outer layer comprises one or more LDPEs.

In some embodiments, the outer layer includes a low density polyethylene having a density of 0.900 to 0.940 g/cm³. All individual values and subranges of 0.900 to 0.940 g/cm³ are included herein and disclosed herein; for example, the density of the low density polyethylene can be from a lower limit of 0.900, 0.902, 0.904, 0.906, 0.908, 0.910, 0.915, 0.918 or 0.920 g/ cm³ to an upper limit of 0.920, 0.925, 0.930, 0.935, or 0.940 g/cm³. In some embodiments, the low density polyethylene has a density from 0.910 to 0.935 g/cm³.

In some embodiments, the low density polyethylene has a melt index (I₂) less than or equal to 20 g/10 minutes. All individual values and subranges from 20 g/10 minutes are included herein and disclosed herein. For example, the low density polyethylene can have an I₂ upper limit of 20, 18, 15, 14, 13, 12, 11, 10, 9, 8, 7, 6, 5, 4, 3.5, 3, 2.5, 2, 1.9, 1.8, 1.7, 1.6, 1.5, 1.4, 1.3, 1.2, or 1.1 g/10 minutes. In a particular aspect, the low density polyethylene has an 12 with a lower limit of 0.1 g/10 minutes. All individual values and subranges from 0.1 g/10 minutes are included herein and disclosed herein. For example, the low density polyethylene can have an 12 greater than or equal to 0.1, 0.2, 0.3, 0.4, 0.45, or 0.5.

Examples of low density polyethylenes that can be used in the outer layer in some embodiments include DOW™ low density polyethylenes commercially available from The Dow Chemical Company, such as DOW™ LDPE 150E, DOW™ LDPE 320E, DOW™ LDPE 450E, and DOW™ LDPE 722.

In some embodiments, the outer layer comprises at least one linear low density polyethylene (as described above) and a low density polyethylene (as described above).

In some embodiments, the polymer blend forming the outer layer of the multilayer polyethylene film comprises a significant amount of the ethylene-based polymer. In some embodiments, the polymer blend comprises at least 60 wt. % of the ethylene-based polymer, based on the weight of the polymer blend. The polymer blend comprises at least 70 wt. % of the ethylene-based polymer, based on the weight of polymer blend, in some embodiments. In some embodiments, the polymer blend comprises at least 80 wt. % of the ethylene-based polymer, based on the weight of polymer blend. In some embodiments, the polymer blend comprises at least 85 wt. % of the ethylene-based polymer, based on the weight of the polymer blend. The polymer blend comprises up to 90 wt. % of the ethylene-based polymer, based on the weight of the polymer blend in some embodiments.

As described above, in various embodiments, the polymer blend further comprises an ethylene acid copolymer. The ethylene acid copolymer is the polymerized reaction product of ethylene monomer, a monomer selected from the group consisting of monocarboxylic acids and dicarboxylic acids. In various embodiments, the ethylene monomer is included in an amount of at least 50 wt. % based on the total weight of the monomers present in the ethylene acid copolymer. For example, the ethylene monomer may be included in an amount of 50 wt. %, 60 wt. %, 70 wt. %, 75 wt. %, 80 wt. %, 85 wt. %, 90 wt. %, 95 wt. %, or even 98 wt. % based on the total weight of the monomers present in the ethylene acid copolymer. The ethylene monomer may be included in an amount of from 50 wt. % to 98 wt. %, 50 wt. % to 90 wt. %, 50 wt. % to 80 wt. %, or from 50 wt. % to 75 wt. %, for example.

In various embodiments, the acid monomer is selected from the group consisting of monocarboxylic acids and dicarboxylic acids. In some embodiments, the acid monomer is a monocarboxylic acid. In some embodiments, the monocarboxylic acid monomer is acrylic acid, methacrylic acid, or combinations thereof. The monomer is included in an amount of from 1 to 30 wt. % based on the total weight of the monomers present in the ethylene acid copolymer. For example, the ethylene acid copolymer may include 2 wt. %, 5 wt. %, 10 wt. %, 15 wt. %, 20 wt. %, 25 wt. %, or even 30 wt. % monomer based on the total weight of the monomers present in the ethylene acid copolymer. The ethylene acid copolymer may include from 1 to 30 wt. %, from 5 wt. % to 25 wt. %, or from 10 wt. % to 20 wt. % monomer based on the total weight of the monomers present in the ethylene acid copolymer.

In some embodiments, the ethylene acid copolymer has a melt index (I₂) of 0.7 to 35 g/10 minutes. All individual values and subranges within 0.7 to 35 g/10 minutes are included herein and disclosed herein. For example, the ethylene acid copolymer can have an I₂ upper limit of 35, 33, 30, 29, 27, 25, 24, 21, 20, 18, 15, 14, 13, 12, 11, 10, 9, 8, 7, 6, 5, 4, 3.5, 3, 2.5, or 2 g/10 minutes. For example, the ethylene acid copolymer can have an I₂ greater than or equal to 0.7, 0.8, 0.9, 1, 2, 3, 4, 5, 6, 7, 8, 9, or 0.5. In some embodiments, the ethylene acid copolymer has an I₂ of 1 to 30 g/10 minutes, and in other embodiments, from 2 to 27 g/ 10 minutes.

In various embodiments, the polymer blend includes from 3 to 40 wt. % ethylene acid copolymer. For example, the polymer blend may include 3 wt. %, 5 wt. %, 10 wt. %, 20 wt. %, 25 wt. %, 30 wt. %, or even 40 wt. % ethylene acid copolymer based on a total weight of the polymer blend. The polymer blend may include from 3 to 40 wt. % ethylene acid copolymer, from 5 to 30 wt. % ethylene acid copolymer, or from 10 to 25 wt. % ethylene acid copolymer, for example.

In some embodiments, the polymer blend optionally include an acrylate monomer. For example, in some embodiments in which the ethylene acid copolymer is the reaction product of a mixture including alkyl acrylate monomer, the alkyl acrylate monomer may be methyl acrylate, ethyl acrylate, n-butyl acrylate or iso-butyl acrylate, or combinations thereof. The alkyl acrylate monomer may be included in amounts of from 0 to 10 wt. %, from greater than 0 to 10 wt. %, or from 1 to 8 wt. % of alkyl acrylate monomer, based on the total weight of the monomers present in the ethylene acid copolymer. For example, the alkyl acrylate monomer may be included in an amount of 1 wt. %, 2 wt. %, 3 wt. %, 4 wt. %, 5 wt. %, 6 wt. %, 7 wt. %, or 8 wt. % based on the total weight of the monomers present in the ethylene acid copolymer. The alkyl acrylate may be monomer may be included in amount of from 1 to 8 wt. %, from 2 to 7 wt. %, or from 3 to 6 wt. %, for example.

Examples of commercially available ethylene acid copolymers that can be used in the outer layer of the multilayer polyethylene film, in some embodiments, include NUCREL™ ethylene acid copolymers commercially available from The Dow Chemical Company, such as NUCREL™ AE, NUCREL™ 0427HS, and NUCREL™ 0403.

As previously noted, it is believed that the acid content of the polymer blend and the difference between the melt indexes (I₂) of the ethylene acid copolymer and the ethylene-based polymer facilitates adhesion between the metal and the outer layer of the polyethylene film.

In embodiments of the present invention, the acid content of the polymer blend in the outer layer of the multilayer polyethylene film is greater than 0.2%. In some embodiments, the acid content of the polymer blend in the outer layer is 0.3% or greater. The acid content of the polymer blend in the outer layer is 1% or less in some embodiments. The acid content of the polymer blend in the outer layer is 0.5% or less in some embodiments. In some embodiments, the acid content of the polymer blend in the outer layer is from 0.2% to 1%, and from 0.2% to 0.5% in other embodiments. The acid content of the polymer blend is calculated by first determining the average acid content of the ethylene acid copolymer based on the weight percent of acid monomer incorporated therein using techniques known to those having ordinary skill in the art, and then using that acid content (of the e1thylene acid copolymer) to calculate the acid content in the polymer blend based on the weight percent of the ethylene acid copolymer in the polymer blend.

For example, the acid content of ethylene methacrylic acid (EMAA) copolymer is defined as the methacrylic acid (MAA) monomer weight percent of the total EMAA copolymer. For ethylene acrylic acid (EAA) copolymers, the acid concentration is adjusted to corresponding methacrylic acid based on the molecular weight. One example of converting acrylic acid content (AA %) to methacrylic acid content (MAA %) is:

MAA %=(86/72)*AA %,

as the molecular weight of acrylic acid is 72 and the molecular weight of methacrylic acid is 86.

Regarding the difference between the melt index (I₂) of the ethylene acid copolymer and the ethylene-based polymer, in some embodiments, the difference (I₂ of ethylene acid copolymer−I₂ of ethylene-based polymer, or “melt index difference”) is less than 18. In some embodiments, the melt index difference is at least 2. In some embodiments, the melt index difference is at least 3. In some embodiments, the melt index difference is from 2 to 18. The melt index difference is 2 to 15 in some embodiments. The melt index difference in some embodiments is from 3 to 18. The melt index difference is from 3 to 15 in some embodiments. If there are multiple polyethylenes in the polymer blend, the melt index of the blend of polyethylenes is used.

In some embodiments, the outer layer of the multilayer polyethylene film further comprises 200 to 4000 ppm fluoroelastomer processing aid based on the weight of the outer layer of the polyethylene film. The inclusion of fluoroelastomer processing aid, in some embodiments, is believed to further improve the adhesion of the metal layer to the outer layer of the film.

The fluoropolymer processing aids useful in this invention are elastomeric fluoropolymers (fluoroelastomers), which are fluorine containing organic polymers having T_{g} values less than 25° C. and which exhibit little or no crystallinity. Fluorinated monomers which may be copolymerized to yield suitable fluoropolymers include vinylidene fluoride, hexafluoropropylene, chlorotrifluoroethylene, tetrafluoroethylene and perfluoroalkyl perfluorovinyl ethers. Specific examples of the fluoropolymers which may be employed include copolymers of vinylidene fluoride and a comonomer selected from hexafluoropropylene, chlorotrifluoroethylene, 1-hydropentafluoropropylene, and 2-hydropentafluoropropylene; copolymers of vinylidene fluoride, tetrafluoroethylene, and hexafluoropropylene or 1- or 2-hydropentafluoropropylene; and copolymers of tetrafluoroethylene, propylene and, optionally, vinylidene fluoride, all of which are known in the art. In some cases these copolymers may also include bromine-containing comonomers as taught in U.S. Pat. No. 4,035,565, or terminal iodo-groups, as taught in U.S. Pat. No. 4,243,770. In some embodiments, the fluoropolymers employed in the outer layer of the polyethylene film contain a fluorine to carbon molar ratio of at least 1:2 and, in some further embodiments, at least 1:1. Particularly desirable fluoropolymers for use as fluoropolymer processing aids comprise copolymerized units of i) vinylidene fluoride/hexafluoropropylene; ii) vinylidene fluoride/hexafluoropropylene/tetrafluoroethylene; iii) tetrafluoroethylene/propylene; or iv) tetrafluoroethylene/propylene/vinylidene fluoride. Examples of suitable fluoropolymers that may be employed in the outer layer of polyethylene films according to some embodiments of the present invention are disclosed in U.S. Pat. Nos. 6,774,164, 6,642,310, 6,610,408, 6,599,982, 6,512,063, 6,048,939, 5,707,569, 5,587,429, 5,010,130, 4,855,360, 4,740,341, 3,334,157, and 3,125,547,

The polyethylene films used in some embodiments of the present invention can comprise 200 to 4000 ppm fluoroelastomer processing aid based on the weight of the outer layer of the polyethylene film. In some embodiments, the polyethylene films can comprise 200 to 1,500 ppm fluoroelastomer processing aid based on the weight of the outer layer of the polyethylene film, or 200 to 1,000 ppm fluoroelastomer processing aid based on the weight of the outer layer of the polyethylene film.

As shown in some embodiments of the present invention, it has been found that the inclusion of even small amounts of the fluoroelastomer processing aid in the outer layer of the polyethylene can significantly improve the adhesion of the metal layer to the film.

Non-limiting examples of commercially available fluoroelastomer processing aids that can be used in embodiments of the present invention include Dynamar Polymer Processing Additives commercially available from 3M, such as Dynamar FX 9613.

In some embodiments, in addition to the fluoroelastomer processing aid, the polyethylene film may further comprise one or more interfacial agents. An “interfacial agent” refers to a thermoplastic polymer which is characterized by (1) being in the liquid state (or molten) at the extrusion temperature, (2) having a lower melt viscosity than the fluoroelastomer processing aid, and (3) freely wets the surface of the fluoroelastomer processing aid in the extrudable composition. Examples of such interfacial agents are disclosed in U.S. Pat. No. 7,652,102.

The outer layer of the polyethylene film may contain one or more additives as is generally known in the art. Such additives include antioxidants, such as IRGANOX 1010 and IRGAFOS 168 (commercially available from BASF), ultraviolet light absorbers, antistatic agents, pigments, dyes, nucleating agents, fillers, slip agents, fire retardants, plasticizers, processing aids, lubricants, stabilizers, smoke inhibitors, viscosity control agents, surface modification agents, and anti-blocking agents.

As a multilayer film, the polyethylene film can further comprise other layers typically included in multilayer films depending on the application including, for example, sealant layers, barrier layers, tie layers, other polyethylene layers, etc.

As one example, in some embodiments, the polyethylene film can comprise another layer (Layer B, with Layer A being the previously discussed outer layer) having a top facial surface and a bottom facial surface, wherein the top facial surface of Layer B is in adhering contact with a bottom facial surface of Layer A. In some such embodiments, Layer B can be a sealant layer formed from one or more ethylene-based polymers as known to those of skill in the art to be suitable for use in a sealant layer.

However, as noted above, Layer B can comprise any number of other polymers or polymer blends. Depending on the composition of the additional layer and the multilayer film, in some embodiments, the additional layer can be coextruded with other layers in the film.

It should be understood that any of the foregoing layers can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

The polyethylene films used in the multilayer structures are comprised substantially of polyethylene. In some embodiments, polyethylene film comprises 95 weight percent or more polyethylene based on the total weight of the film. In other embodiments, the polyethylene film comprises 96 weight percent or more, 97 weight percent or more, 98 weight percent or more, or 99 weight percent or more polyethylene based on the total weight of the film.

Such polyethylene films can have a variety of thicknesses depending, for example, on the number of layers, the intended use of the film, and other factors. Such polyethylene films, in some embodiments, have a thickness prior to biaxial orientation of 320 to 3200 microns (typically, 640-1920 microns).

The polyethylene films can be formed using techniques known to those of skill in the art based on the teachings herein. For example, the films can be prepared as blown films (e.g., water quenched blown films) or cast films. For example, in the case of multilayer polyethylene films, for those layers that can be coextruded, such layers can be coextruded as blown films or cast films using techniques known to those of skill in the art based on the teachings herein.

In some embodiments, the polyethylene film is oriented prior to depositing the metal layer on the outer layer of the film. For example, the polyethylene film can be uniaxially oriented (e.g., uniaxially oriented in the machine direction) or biaxially oriented using techniques known to those having ordinary skill in the art based on the teachings herein.

In some embodiments, the polyethylene film is biaxially oriented using a tenter frame sequential biaxial orientation process. Such techniques are generally known to those of skill in the art. In other embodiments, the polyethylene film can be biaxially oriented using other techniques known to those of skill in the art based on the teachings herein, such as double bubble orientation processes. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

In some embodiments, the polyethylene film can be oriented in the machine direction at a draw ratio of 2:1 to 6:1, or in the alternative, at a draw ratio of 3:1 to 5:1. The polyethylene film, in some embodiments, can be oriented in the cross direction at a draw ratio of 2:1 to 9:1, or in the alternative, at a draw ratio of 3:1 to 8:1. In some embodiments, the polyethylene film is oriented in the machine direction at a draw ratio of 2:1 to 6:1 and in the cross direction at a draw ratio of 2:1 to 9:1. The polyethylene film, in some embodiments, is oriented in the machine direction at a draw ratio of 3:1 to 5:1 and in the cross direction at a draw ratio of 3:1 to 8:1.

In some embodiments, the ratio of the draw ratio in the machine direction to the draw ratio in the cross direction is from 1:1 to 1:2.5. In some embodiments, the ratio of the draw ratio in the machine direction to the draw ratio in the cross direction is from 1:1.5 to 1:2.0.

In some embodiments, the biaxially oriented polyethylene film has an overall draw ratio (draw ratio in machine direction X draw ratio in cross direction) of 8 to 54. The biaxially oriented polyethylene film, in some embodiments, has an overall draw ratio (draw ratio in machine direction X draw ratio in cross direction) of 9 to 40.

After orientation, the biaxially oriented polyethylene film has a thickness of 10 to 60 microns in some embodiments. In some embodiments, the biaxially oriented polyethylene film has a thickness of 20 to 50 microns.

In some embodiments when the multilayer film is uniaxially or monoaxially oriented, the film is oriented in the machine direction only. Various processing parameters are considered suitable for stretching in the machine direction as known to those having ordinary skill in the art based on the teachings herein. For example, the uniaxially oriented, multilayer film may be oriented in the machine direction at a draw ratio greater than 1:1 and less than 8:1, or at a draw ratio from 4:1 to 8:1. After orientation, the machine direction oriented polyethylene film has a thickness of 10 to 60 microns in some embodiments. In some embodiments, the machine direction oriented polyethylene film has a thickness of 20 to 50 microns.

### Metal Layer

The multilayer structure further comprises a metal layer comprising a metal deposited on the outer layer (comprising the polymer blend of ethylene-based polymer and ethylene acid copolymer described herein) of the polyethylene film. The metal layer can be applied to the outer layer of the polyethylene film using vacuum metallization. Vacuum metallization is a well-known technique for depositing metals in which a metal source is evaporated in a vacuum environment, and the metal vapor condenses on the surface of the film to form a thin layer as the film passes through the vacuum chamber.

The metals that can be deposited on the outer layer of the biaxially oriented polyethylene film include Al, Si, Zn, Au, Ag, Cu, Ni, Cr, Ge, Se, Ti, Sn, or oxides thereof In some embodiments, the metal layer is formed from aluminum or oxides of aluminum (e.g., Al₂O₃).

With the metal layer on the polyethylene film, the multilayer structure can be characterized by its optical density when measured as described in the TEST METHODS section below. In some embodiments, the multilayer structure has an optical density of 1.0 to 3.0. The multilayer structure has an optical density of 2.0 to 2.8 in some embodiments.

The metal layer advantageously provides a good barrier to oxygen and water vapor.

### Multilayer Structures

Multilayer structures of the present invention, in some embodiments, comprise a polyethylene film and a metal layer deposited thereon (as described above). The incorporation of the ethylene acid copolymer to provide the specified acid content, and the difference between the melt index of the ethylene acid copolymer and the melt index of the the ethylene-based polymer, in the outer layer of the polyethylene film advantageously provides improved adhesion between the metal and the outer layer of the film which benefits the performance of the film and the other structures (e.g., laminates) in which it may be incorporated. As noted above, the metal layer can provide good barrier properties, and the inclusion of a sealant layer in the polyethylene film can permit the film to serve as a sealant film in a multilayer structure.

### Laminates

Multilayer structures of various embodiments described herein can be used to form laminates. Such laminates can be formed from any of the multilayer structures described herein.

Laminates may include the multilayer structures of various embodiments adhesively contacted with one or more additional films. For example, a multilayer structure of one or more embodiments described hereinabove may be adhered to a second film. The second film may include, for example, polyethylene, polyamide, polyethylene terephthalate, polypropylene, or combinations thereof. The multilayer structure may be adhered to the second film through an adhesive layer, as known to those having ordinary skill in the art.

### Articles

Multilayer structures or laminates of the present invention can be used to form articles such as packages. Such articles can be formed from any of the multilayer structures or laminates described herein.

Examples of articles that can be formed from multilayer structures or laminates of the present invention can include flexible packages, pouches, stand-up pouches, and pre-made packages or pouches. In some embodiments, multilayer structures or articles of the present invention can be used for food packages. Examples of food that can be included in such packages include meats, cheeses, cereal, nuts, juices, sauces, and others. Such articles can be formed using techniques known to those of skill in the art based on the teachings herein and based on the particular use for the package (e.g., type of food, amount of food, etc.).

### Test Methods

Unless otherwise indicated herein, the following analytical methods are used in describing aspects of the present invention:

### Density

Samples for density measurement are prepared according to ASTM D 1928. Polymer samples are pressed at 190° C. and 30,000 psi (207 MPa) for three minutes, and then at 21° C. and 207 MPa for one minute. Measurements are made within one hour of sample pressing using ASTM D792, Method B.

### Melt Index

Melt indices I₂ (or I2) and I₁₀ (or I10) are measured in accordance with ASTM D-1238 at 190° C. and at 2.16 kg and 10 kg load, respectively. Their values are reported in g/10 min. “Melt flow rate” is used for polypropylene based resins and determined according to ASTM D1238 (230° C. at 2.16 kg).

### Melt Flow Rate

Melt flow rates are measured in accordance with ASTM D-1238 or ISO 1133 (230° C.; 2.16 kg).

### Optical Density

The optical density of a metallized film (e.g., a multilayer structure comprising a polyethylene film with a metal layer deposited on it) is measured using an optical density meter (Model No. LS177 from Shenzhen Linshang Technology).

Some embodiments of the invention will now be described in detail in the following Examples.

### EXAMPLES

The following materials are used in blown films to be evaluated as Examples:

TABLE 1

| | | | Melt |
|---|---|---|---|
| | | | Index, I₂ |
| | Commercial Name | Density | (g/10 |
| Material | (Supplier) | (g/cm³ | minutes) |
| Low Density Polyethylene | DOW ™ LDPE 150E | 0.921 | 0.25 |
| (“LDPE-1”) | (The Dow Chemical | | |
| | Company (“Dow”)) | | |
| Low Density Polyethylene | DOW ™ LDPE 320E | 0.925 | 1 |
| (“LDPE-2”) | (Dow) | | |
| Low Density Polyethylene | DOW ™ LDPE 450E | 0.923 | 2 |
| (“LDPE-3”) | (Dow) | | |
| Low Density Polyethylene | AGILITY ™ EC 7000 | 0.919 | 3.9 |
| (“LDPE-4”) | (Dow) | | |
| Low Density Polyethylene | DOW ™ LDPE 722 | 0.918 | 8 |
| (“LDPE-5”) | (Dow) | | |
| Linear Low Density Polyethylene | DOWLEX ™ 2045G | 0.92 | 1 |
| (“LLDPE-1”) | (Dow) | | |
| Linear Low Density Polyethylene | DOWLEX ™ 2045.11G | 0.922 | 1 |
| (“LLDPE-2”) | (Dow) | | |
| Linear Low Density Polyethylene | Ziegler-Natta Catalyzed | 0.935 | 1 |
| (“LLDPE-3”) | LLDPE (Dow) with 300 | | |
| | ppm Dynamar FX 9613 | | |
| | (3M) | | |
| Ethylene Methacrylic Acid | NUCREL ™ AE | 0.92 | 10 |
| Copolymer (“EMA-1”) | (Dow) | | |
| Ethylene Methacrylic Acid | NUCREL ™ 0427HS | 0.93 | 25 |
| Copolymer (“EMA-2”) | (Dow) | | |

The above materials are used to make a number of three layer blown films using a blown film line from Gloucester Engineering. Each film is prepared using the same conditions. The specified formulations for each film are provided through three extruders (one extruder for each layer). If a layer includes multiple resins, the resins are dry blended before being loaded into the extruder. The blow up rate is 2.3 with an output rate of 18 kg/h. Each film has a nominal thickness of 50 microns in a layer ratio (Outer Layer:Core Layer:Inner Layer) of 1:3:1 (from Outer Layer to Inner Layer, 10 micron:30 micron:10 micron respectively). The blown film conditions are as follows:

TABLE 2

| Outer Layer | | Core Layer | | Inner Layer | | Die | |
|---|---|---|---|---|---|---|---|
| | Temp | | Temp | | Temp | | Temp |
| Zone | (° C.) | Zone | (° C.) | Zone | (° C.) | Zone | (° C.) |
| Feed | 40 | Feed | 40 | Feed | 40 | Block | 210 |
| Barrel 1 | 190 | Barrel 1 | 190 | Barrel 1 | 190 | Low Die | 210 |
| Barrel 2 | 210 | Barrel 2 | 210 | Barrel 2 | 210 | Mid Die | 210 |
| Barrel 3 | 210 | Barrel 3 | 210 | Barrel 3 | 210 | Upr Die | 210 |
| Barrel 4 | 210 | Barrel 4 | 210 | Barrel 4 | 210 | | |
| Clamp | 210 | Clamp | 210 | Clamp | 210 | | |
| Adapter | 210 | Adapter | 210 | Adapter | 210 | | |

The following blown films are made:

TABLE 3

| | | | | FPA |
|---|---|---|---|---|
| | Outer Layer | Core Layer | Inner Layer | Content |
| | (10 microns) | (30 microns) | (10 microns) | (weight) |
| Film 1 | 85% LDPE-1 | 85% LDPE-1 | 85% LDPE-1 | 0 |
| | 15% EMA-1 | 15% EMA-1 | 15% EMA-1 | |
| Film 2 | 85% LDPE-2 | 85% LDPE-2 | 85% LDPE-2 | 0 |
| | 15% EMA-1 | 15% EMA-1 | 15% EMA-1 | |
| Film 3 | 85% LDPE-3 | 85% LDPE-3 | 85% LDPE-3 | 0 |
| | 15% EMA-1 | 15% EMA-1 | 15% EMA-1 | |
| Film 4 | 85% LDPE-4 | 85% LDPE-4 | 85% LDPE-4 | 0 |
| | 15% EMA-1 | 15% EMA-1 | 15% EMA-1 | |
| Film 5 | 85% LDPE-5 | 85% LDPE-5 | 85% LDPE-5 | 0 |
| | 15% EMA-1 | 15% EMA-1 | 15% EMA-1 | |
| Film 6 | 93% LDPE-5 | 93% LDPE-5 | 93% LDPE-5 | 0 |
| | 7% EMA-2 | 7% EMA-2 | 7% EMA-2 | |
| Film 7 | 85% LLDPE-1 | 100% LLDPE-1 | 85% LLDPE-1 | 0 |
| | 15% EMA-1 | | 15% EMA-1 | |
| Film 8 | 80% LLDPE-1 | 100% LLDPE-1 | 80% LLDPE-1 | 0 |
| | 20% EMA-1 | | 20% EMA-1 | |
| Film 9 | 85% LLDPE-2 | 100% LLDPE-1 | 85% LLDPE-2 | 0 |
| | 15% EMA-1 | | 15% EMA-1 | |
| Film 10 | 85% LLDPE-3 | 100% LLDPE-1 | 100% LLDPE-1 | 300 ppm |
| | 15% EMA-1 | | | |
| Film A | 100% LDPE-1 | 100% LDPE-1 | 100% LDPE-1 | 0 |
| Film B | 93% LDPE-4 | 93% LDPE-4 | 93% LDPE-4 | 0 |
| | 7% EMA-2 | 7% EMA-2 | 7% EMA-2 | |
| Film C | 93% LDPE-1 | 93% LDPE-1 | 93% LDPE-1 | 0 |
| | 7% EMA-2 | 7% EMA-2 | 7% EMA-2 | |
| Film D | 100% LLDPE-1 | 100% LLDPE-1 | 100% LLDPE-1 | 0 |
| Film E | 95% LLDPE-1 | 100% LLDPE-1 | 95% LLDPE-1 | 0 |
| | 5% EMA-1 | | 5% EMA-1 | |
| Film F | 90% LLDPE-1 | 100% LLDPE-1 | 90% LLDPE-1 | 0 |
| | 10% EMA-1 | | 10% EMA-1 | |
| Film G | 100% LLDPE-2 | 100% LLDPE-1 | 100% LLDPE-2 | 0 |

The column in Table 3 labeled “FPA Content” refers to the amount of fluoroelastomer processing aid in the film, based on the weight of the outer layer of the polyethylene film. Once metallized, as discussed below, Films 1-10 will become Inventive Multilayer Structures 1-10 and Films A-G will become Comparative Multilayer Structures A-G.

After the films are prepared, they are stored at ambient conditions for over one week to allow for migration of additives to the film surface in order to simulate commercial conditions. Following storage for over a week, the films are corona treated using techniques known to those having ordinary skill in the art.

Following corona treatment, the Films are metallized as follows. Metallization of the Films is done in a lab scale vacuum deposition chamber produced by Shenyang Vacuum Technology Institute. After corona treatment, a Film is taped onto the substrate holder. An aluminum wire is inserted into the container of the resistance heater (heating boat). A vacuum pump is firstly run to induce a pressure lower than 50 Pa in the chamber, with a cooling system at 15° C. The chamber evacuation set-up is changed from vacuum pump to a molecular pump by opening the cut-off valve quickly, closing the corner valve, and opening the butterfly valve. By such operation, the chamber is evacuated by the molecular pump to a much higher vacuum, while the vacuum pump is not protecting the operation of molecular pump. When the vacuum level reaches 3*10⁻³ Pa, the heating boat is turned on. A mask is adjusted to cover the substrate surface temporarily, while a spinning component is turned on to drive a constant speed spinning of the substrate to facilitate a more uniform deposition. A thickness monitor is then turned on, which is based on QCM (quartz crystal microbalance, Fil-Tech Inc.). The current on the heating boat is tuned in order to get a required aluminum deposition rate (normally 10-50 A/s), and then the mask above the substrate is quickly removed and the thickness reading on the QCM reset to zero at the same moment. The deposition continues until a target thickness of 40-60 nanometers is achieved.

The heating boat is then turned off immediately. The molecular pump is stopped but not turned off until the speed dropped to zero. Protection from the vacuum pump also continued during this stage. After turning off the vacuum pump, the chamber is ventilated to atmosphere. The metallized product is then taken out of the chamber and placed in dust-preventing boxes.

The bonding strength of the metal layer to the outer layer of the Film is then measured for each Multilayer Structure as follows. The Multilayer Structure is heat sealed to a 100 micron film made from ethylene acrylic acid copolymer having an acrylic acid content of ˜7% (“the EAA film”), with the metal layer of the Multilayer Structure being in contact with the EAA film. The Multilayer Structure and the EAA film are heat sealed by placing the films between an upper jaw at 110° C. and a lower jaw at 70° C., with the upper jaw being in contact with the EAA film and the lower jaw in contact with the Multlayer Structure. The jaws are in contact with the EAA film and the Multilayer Structure for 20 seconds under pressure of 5 bars. After 24 hours aging at room temperature, the bonding strength is then measured using an Instron 5567 tensile machine, by measuring T-Peel at a testing speed of 12 inches/minute with a load cell of 100 N. The average value use used as the bonding strength between the Film and the metal layer.

Inventive Multilayer Structures 1-6 and Comparative Multilayer Structures A-C consider Multilayer Structures used low density polyethylene as the ethylene-based polymer in the outer layer of the Film. The results are shown in Table 4:

TABLE 4

| | | Bonding | Acid | |
|---|---|---|---|---|
| | | Strength | Content | Melt Index |
| | Film | (N/15 mm) | (weight) | Difference |
| Inventive Multilayer Structure 1 | Film 1 | 2.8 | 0.3 | 10.75 |
| Inventive Multilayer Structure 2 | Film 2 | 2.9 | 0.3 | 10 |
| Inventive Multilayer Structure 3 | Film 3 | 2.3 | 0.3 | 9 |
| Inventive Multilayer Structure 4 | Film 4 | 3.1 | 0.3 | 7.1 |
| Inventive Multilayer Structure 5 | Film 5 | 6.1 | 0.3 | 3 |
| Inventive Multilayer Structure 6 | Film 6 | 6.5 | 0.28 | 17 |
| Comparative Multilayer Structure A | Film A | 1.4 | 0 | — |
| Comparative Multilayer Structure B | Film B | 1.7 | 0.28 | 20.1 |
| Comparative Multilayer Structure C | Film C | 0.9 | 0.28 | 24.75 |

The acid content is the acid content in the outer layer of the Film. The Melt Index Difference is the difference between the melt index (I₂) of the ethylene acid copolymer (EMA-1) and the melt index (I₂) of the ethylene-based polymer.

As shown above, when 0.3% acid content is incorporated in the outer layer, the bonding strength increases from 1.4 to 2.8 (compare Comparative Multilayer Structure A and Inventive Multilayer Structure 1). When the Melt Index Difference is less than 18, the bonding strength is considerably better (Inventive Multilayer Structures 1-6) than when it is greater than 18 (Comparative Multilayer Structures B-C).

Inventive Multilayer Structures 7-10 and Comparative Multilayer Structures D-G consider Multilayer Structures used linear low density polyethylene as the ethylene-based polymer in the outer layer of the Film. The results are shown in Table 5:

TABLE 5

| | | Bonding | Acid | |
|---|---|---|---|---|
| | | Strength | Content | Melt Index |
| | Film | (N/15 mm) | (weight) | Difference |
| Inventive Multilayer Structure 7 | Film 7 | 3.5 | 0.3 | 10 |
| Inventive Multilayer Structure 8 | Film 8 | 6.4 | 0.4 | 10 |
| Inventive Multilayer Structure 9 | Film 9 | 1.3 | 0.3 | 10 |
| Inventive Multilayer Structure 10 | Film 10 | 2.3 | 0.3 | 10 |
| Comparative Multilayer Structure D | Film D | 0.96 | 0 | — |
| Comparative Multilayer Structure E | Film E | 1.5 | 0.1 | 10 |
| Comparative Multilayer Structure F | Film F | 1.1 | 0.2 | 10 |
| Comparative Multilayer Structure G | Film G | 0.31 | 0 | — |

The acid content is the acid content in the outer layer of the Film. The Melt Index Difference is the difference between the melt index (I₂) of the ethylene acid copolymer (EMA-1 or EMA-2) and the melt index (I₂) of the ethylene-based polymer.

As shown above, the inclusion of 0.2% acid content or less in the outer layer of the Films did not significantly improve the bonding strength (see Comparative Multilayer Structures D-F). In Comparative Multilayer Structure G, the ethylene-based polymer (LLDPE-2) included a slip agent and anti-block and exhibits a reduced bonding strength relative to Comparative Multilayer Structure D. When the acid content in the outer layers of the Films is 0.3% or higher, the bonding strengths show significant improvement (compare Inventive Multilayer Structures 7-8 to Comparative Multilayer Structures D-F, and compare Inventive Multilayer Structure 9 to Comparative Multilayer Structure G). Inventive Multilayer Structure 10 incorporates 300 ppm of a fluoroelastomer processing aid (in addition to having an acid content of 0.3% and Melt Index Difference of 10), and exhibits improved bonding strength.

1. A multilayer structure comprising:
(a) a multilayer polyethylene film, wherein an outer layer of the film comprises a polymer blend of at least one ethylene-based polymer and at least one ethylene acid copolymer, wherein:
(1) the ethylene-based polymer comprises ethylene α-olefin copolymer, ethylene homopolymer, or combinations thereof, wherein the ethylene-based polymer has a density of from 0.900 to 0.970 g/cm³ and a melt index (I₂) of 0.1 to 20 g/10 minutes; and
(2) the ethylene acid copolymer is the polymerized reaction product of at least 50 wt. % ethylene monomer, based on the total weight of the monomers present in the ethylene acid copolymer and from 1 to 30 wt. % of monomer selected from the group consisting of monocarboxylic acids and dicarboxylic acids, based on the total weight of the monomers present in the ethylene acid copolymer, wherein the ethylene acid copolymer has a melt index (I₂) or 0.7 to 35 g/10 minutes,
wherein the difference between the melt index (I₂) of the ethylene acid copolymer and the ethylene-based polymer is less than 18, and wherein the acid content of the polymer blend is greater than 0.2%; and
(b) a metal layer comprising a metal deposited on the outer layer of the polyethylene film.

2. The multilayer structure of claim 1, wherein the ethylene-based polymer is low density polyethylene or linear low density polyethylene.

3. The multilayer structure of claim 1, wherein the acid monomer comprises acrylic acid, methacrylic acid, or combinations thereof.

4. The multilayer structure of claim 1, wherein the metal comprises Al, Si, Zn, Au, Ag, Cu, Ni, Cr, Ge, Se, Ti, Sn, oxides thereof, and combinations thereof.

5. The multilayer structure of claim luny of claims 1, wherein the metal comprises Al metal, oxides of Al, or both.

6. The multilayer structure of claim 1, wherein the metal is deposited on the polyethylene film by vacuum metallization.

7. The multilayer structure of claim 1, wherein the metal layer has a thickness of 20 to 60 nanometers.

8. The multilayer structure of claim 1, wherein the outer layer further comprises 200 to 4000 ppm fluoroelastomer processing aid based on the weight of the outer layer.

9. The multilayer structure of claim 8, wherein the fluoroelastomer processing aid is a copolymer of vinylidene fluoride and a comonomer selected from hexafluoropropylene, chlorotrifluoroethylene, 1-hydropentafluoropropylene, and 2-hydropentafluoropropylene; a copolymer of vinylidene fluoride, tetrafluoroethylene, and hexafluoropropylene or 1- or 2-hydropentafluoropropylene; or a copolymer of tetrafluoroethylene, propylene and, optionally, vinylidene fluoride.

10. The multilayer structure of claim 8, wherein the fluoropolymer processing aid comprises copolymerized units of i) vinylidene fluoride/hexafluoropropylene; ii) vinylidene fluoride/hexafluoropropylene/tetrafluoroethylene;
iii) tetrafluoroethylene/propylene; or iv) tetrafluoroethylene/propylene/vinylidene fluoride.

11. A laminate comprising the multilayer structure of claim 8 adhesively contacted with a second film.

12. The laminate of claim 11, wherein the second film comprises polyamide, polyethylene terephthalate, polypropylene, or polyethylene.

13. An article comprising the laminate of claim 11.

14. An article comprising the multilayer structure of claim 11.
